(19) United States
(12) Patent Application Publication
(10) Pub. No.: US 2006/0206538 A1
(43) Pub. Date: Sep. 14, 2006

(54) System for performing log writes in a database management system

(76) Inventor: Judson Eugene Veazey, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/075,984

(22) Filed: Mar. 9, 2005

(51) Int. Cl. G06F 17/30

(52) U.S. Cl. 707/202

(57) ABSTRACT

A transaction logging system for performing log writes in a database management system. The transaction logging system has an associated operating system and a target storage system to which are written log records representing complete database transactions. The system includes non-volatile memory accessible by the database management system and directly addressable by the operating system. Each time a log record is written from the database management system to non-volatile memory, an acknowledgement is sent to the database management system, to allow a lock corresponding to the log record to be released. Log records are subsequently written from non-volatile memory to the target storage system.

### BACKGROUND

ACID properties (Atomicity, Consistency, Isolation, and Durability) are intrinsic to many database management systems (DBMS) such as Oracle and SQLServer. The atomicity and durability properties depend on logging transactions to durable storage. Prior solutions typically involve logging these transactions to disk drives. Prior database systems have used elaborate logging techniques to improve the reliability of RAM buffers and to implement the transaction semantics. Non-volatile storage has been used by many database systems to reduce the overhead of logging, but the non-volatile storage in these systems is typically disk storage directly associated with the target disk storage system. Therefore, to ensure atomicity and durability of data, a DBMS thread or process must wait until it receives an acknowledgement from the disk drive that the log write was completed. Since disk writes take milliseconds, this method adds to the response time for transactions and adds latency to overall system performance.

Disk Caching Disk (DCD) systems use a small NVRAM cache and a small cache-disk to form a two-level cache. Write data is first assembled in the small NVRAM cache and later logged into the cache-disk. Data in the cache-disk is destaged to the data disk during idle periods. The two-level hierarchical structure acts as a large non-volatile cache. While DCD provides good performance for low to medium traffic workloads, directly applying DCD to high I/O workloads may result in certain problems: DCD requires destaging, which involves reading ‘dirty’ data (e.g. data in write cache that has not been destaged or written to disk), from the cache-disk and writing it into the data disk. The destaging process may become a performance bottleneck at high loads because the destaging read operations and the log write operations will compete for the limited cache-disk bandwidth. Moreover, the read speed of DCD is also slow because some data has to be read from the cache-disk.

One type of prior art system for caching data to be written to disk is shown in FIG. 1. As shown in FIG. 1, DBMS 105 uses system memory 102 to buffer transactions sent to target disk 131 via NIC (network interface card) 115, disk firmware 120, and disk cache 125. Disk cache 125 is typically NVRAM or other type of non-volatile storage. Since disk cache 125 is physically associated with disk 131, the FIG. 1 system essentially consists of non-volatile RAM inside a disk enclosure 130.

The type of system illustrated in FIG. 1 places disk cache memory 125 downstream from the DBMS 105, which requires remote acknowledgement from the disk drive that each log write was completed. The flow of acknowledgement information in the FIG. 1 system includes verification and handshaking messages 107, 109, 112, 117, and 122 (indicated by dashed arrows) transmitted back from target disk 131 to DBMS 105. This acknowledgement procedure significantly increases the response time for database transactions, since handshaking must take place over the path shown by the dashed arrows 122, 117, 112, 109, and 107.

Another prior art system for caching data to be written to disk is shown in FIG. 2. In the system illustrated in FIG. 2, a small amount of non-volatile RAM (NVRAM) 203 and a ‘log’ disk 204 are used to form a two-level hierarchical cache (‘icache’ 202) for iSCSI requests. This system accumulates a number of small write requests, and converts them into large ones (which are termed ‘logs’, but which are not equivalent to individual DBMS transactions) before writing data into remote storage though a network 218, utilizing a log-structured file system to write data into a ‘log disk’ 204 for caching the data. Whenever the amount of newly written data in NVRAM 203 is sufficiently large, or whenever the log disk is free, data is written into the log disk 204. Data stored on log disk 204 is periodically written to target disk 220 via icache 202, iSCSI software 210, and network 218.

The FIG. 2 system localizes SCSI commands to reduce unnecessary traffic over the network 218. In this manner, the system acts as a storage filter to discard a fraction of the data that would otherwise move across the network, thus reducing the bottleneck imposed by limited network bandwidth. The flow of acknowledgement information in the FIG. 2 system includes verification and handshaking messages 212, 213, 214, 215, 216, and 217 (indicated by dashed arrows) transmitted back from target disk 220 to file system 205. This acknowledgement procedure significantly increases the response time for system transactions.

It should be noted that the ‘log’ in the type of system shown in FIG. 2 is not the same entity as a traditional log in database terms. The type of system shown in FIG. 2 attempts to tune an iSCSI link by grouping small TCP/IP transactions into larger ones. It should be noted, with respect to the data flow in the FIG. 2 diagram, that the function of the type of system reflected in FIG. 2 is to reconcile two conflicting protocols—SCSI and TCP/IP—in a manner that retains the reliability of TCP/IP while not reducing the bandwidth available to SCSI. This involves coalescing many small TCP/IP packets into a few large ones.

To avoid losing packets (and thereby reducing network reliability), intermediate data structures are saved into NVRAM 203, in the FIG. 2 system. Thus, the iSCSI system of FIG. 2 functions to ensure protocol reliability, rather than to preserve the data. In further contrast to established DBMS philosophy, the iSCSI system does not log data as a result of the same events as a DBMS, in which data is logged at the end of each transaction.

What is needed is a method that reduces disk drive response time associated with writes to disk from a DBMS, while maintaining the properties of atomicity and durability.

### SUMMARY

A transaction logging system is provided for performing log writes in a database management system. The transaction logging system has an associated operating system and a target storage system to which are written log records representing complete database transactions. In one embodiment, the system includes non-volatile memory accessible by the database management system and directly addressable by the operating system. Each time a log record is written from the database management system to non-volatile memory, an acknowledgement is sent to the database management system, to allow a lock corresponding to the log record to be released. Log records are subsequently written from non-volatile memory to the target storage system.

### BRIEF DESCRIPTION OF THE DRAWINGS

FIG. 1 shows a prior art system for caching data to be written to disk;

FIG. 2 shows another prior art system for caching data to be written to disk;

FIG. 3 is a diagram of an exemplary embodiment of the present system for performing DBMS log writes to non-volatile memory;

FIG. 4 is a flowchart showing an exemplary set of steps performed in operation of one embodiment of the present system;

FIG. 5 shows an exemplary embodiment of the present system wherein the target disk system is connected directly to non-volatile memory; and

FIG. 6 is a flowchart showing an exemplary set of steps performed in operation of one embodiment of the present system.

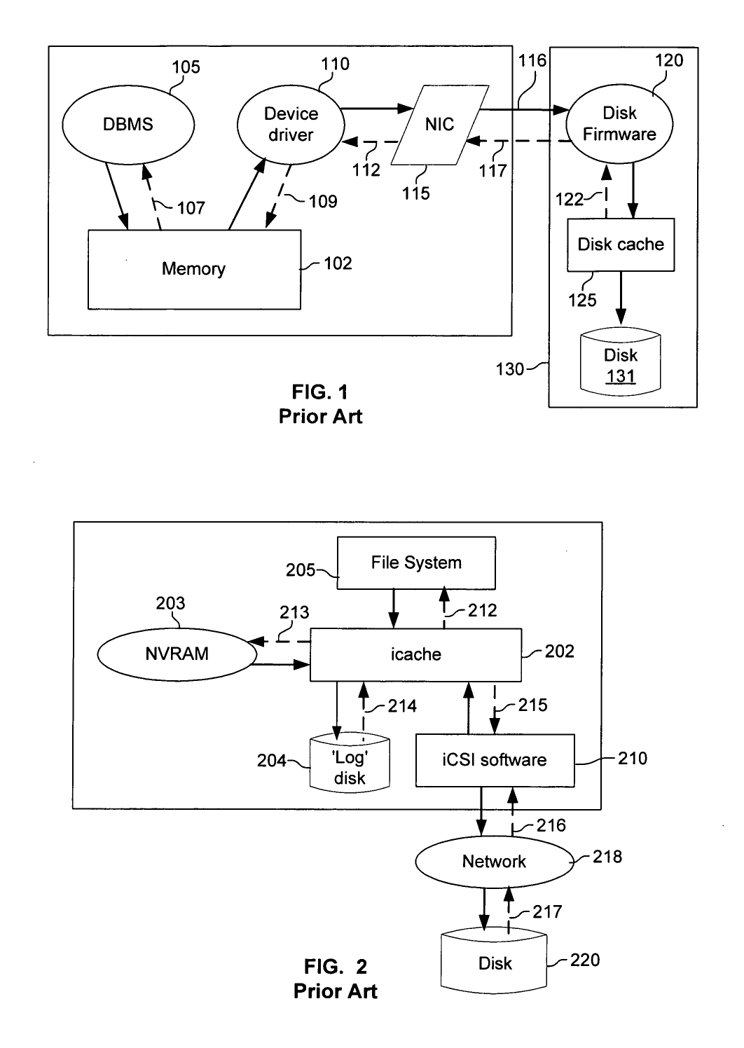

### DETAILED DESCRIPTION

In the present system, a DBMS (database management system) uses non-volatile RAM as a memory-mapped file (where I/O operations are performed via the operating system's file system) or as shared memory (where the DBMS performs raw I/O) for storing DBMS log records. Data residing in non-volatile memory locations is written to disk periodically to make room for new log entries. This can be done either by the operating system (through the memory-mapped file functionality) or, in the case of raw I/O through shared memory, by a separate DBMS thread or process.

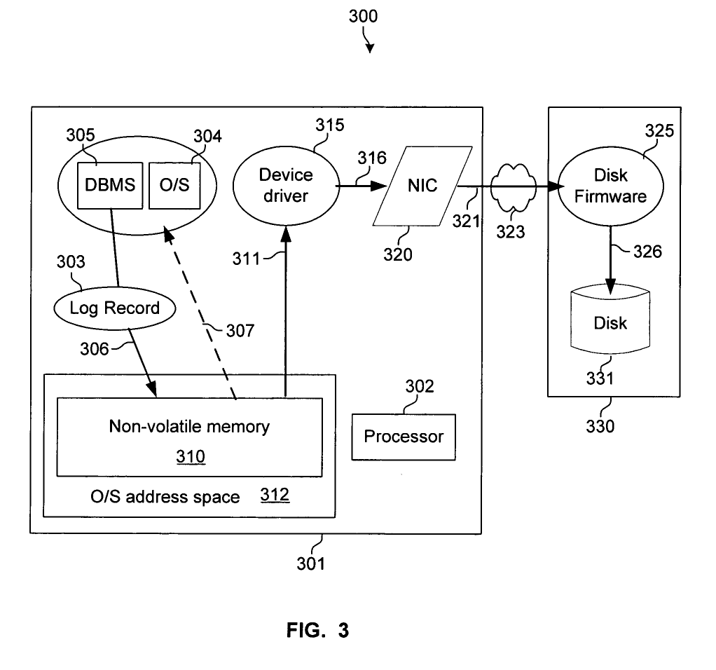

FIG. 3 is a diagram of an exemplary embodiment of the present transaction logging system 300 for performing DBMS log writes to non-volatile memory. As shown in FIG. 3, system 300 comprises local computer system 301, which is connected to a target storage system 330 including target disk 331, and disk controller firmware 325. Local system 301 includes processor 302, DBMS 305 and associated operating system (O/S) 304, non-volatile memory 310, I/O device driver 315, and NIC (network interface card) 320, which can alternatively be any type of adapter or other device suitable for communicating with storage system 330. Storage system 330 typically includes disk firmware 325, and physical disk storage medium 331. Non-volatile memory 310 is directly addressable by the operating system 304, and, more specifically, in an exemplary embodiment, resides in the address space 312 of the operating system.

Non-volatile memory 310 may be NVRAM (which may be RAM that is battery-backed-up, or FRAM [ferroelectric RAM], which does not require battery-back-up), or ‘solid-state disk’ memory built using, for example, MRAM (magnetic RAM) or ARS (atomic resolution storage), or other non-volatile storage device with a short access latency.

The term ‘non-volatile memory’ is used herein to refer to any type of non-rotating, low-latency non-volatile memory, including those types of non-rotating memory noted above, as distinguished from conventional disc memory involving rotating media. A log write to typical non-volatile memory takes a few hundred nanoseconds at most; in comparison, a log write to disk typically takes several milliseconds. On a busy system, a DBMS may issue thousands of log writes per second. The cumulative effect of writing these records to a closely-coupled media such as NVRAM results in a substantial overall performance improvement, in two ways: response time is reduced for the log write, and lock residency time (i.e., the time during which the DBMS holds locks) is also reduced, which in turn reduces queuing delays.

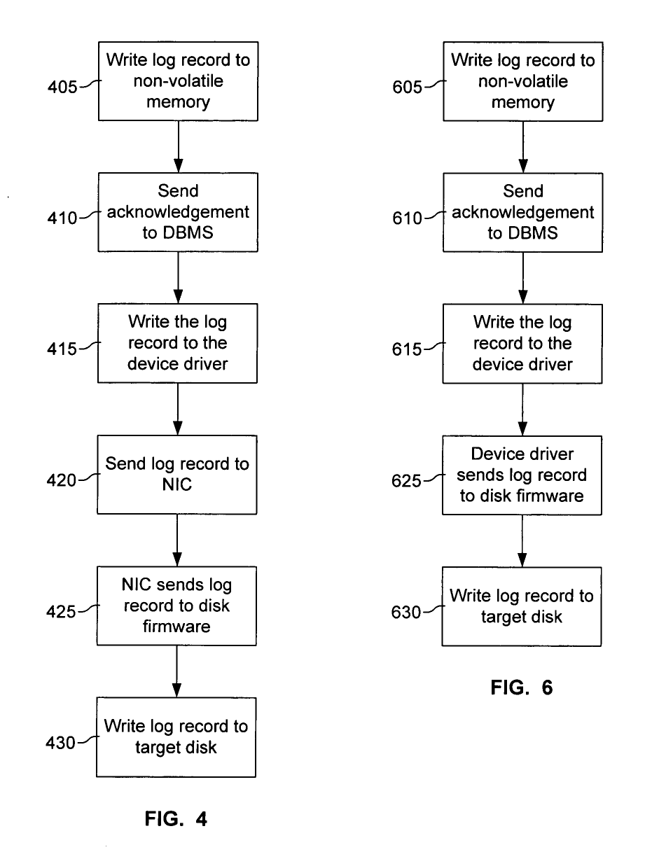

FIG. 4 is a flowchart showing an exemplary set of steps performed in operation of one embodiment of the present system 300. Operation of the present system is best understood by viewing FIGS. 3 and 4 in conjunction with one another. As shown in FIGS. 3 and 4, at step 405, a log record 303 is written from the DBMS 305 to non-volatile memory 310, as indicated by arrow 306. The writing of each log record 303 is initiated by a write request directed to the DBMS from a related application (not shown). In an exemplary embodiment, DBMS 305 is instructed to perform write operations to non-volatile memory 310 via, for example, O/S calls that are employed for allocating memory (e.g., ‘malloc’ calls in UNIX systems).

There are two parts to any DBMS transaction: (1) the changes to the database itself, and (2) the creation of a corresponding log record. In the present system, the DBMS workflow is structured as a series of complete transactions. A ‘complete transaction’ implies both (1) and (2), above. Each DBMS transaction requires a corresponding log record 303 to be written to non-volatile memory 310. These transactions are atomic; either they fail and are cancelled, or they are committed in their entirety. Partial results are not allowed. This atomicity is maintained through a logging and commit protocol, which is well-known in the art.

The present system uses non-volatile memory 310 closely coupled to the DBMS primarily to reduce latency, although DBMS reliability is also improved. Non-volatile memory 310 is more reliable than disk drive storage, and more accessible in the sense that the non-volatile memory in the present system is part of the address space 312 of the operating system, rather than being accessed, for example, via an internal I/O bus, then via a PCI bus interface, and finally through a SCSI card and SCSI bus, where any one of these components can fail or become temporarily unavailable.

At step 410, an acknowledgement 307 is sent to the DBMS 305 from non-volatile memory 310 (as indicated by arrow 307) to communicate that the log record 303 was successfully written to non-volatile memory 310, i.e., to indicate completion of the log record write operation. This allows the current DBMS thread to release any latches or locks associated with the write operation, thus allowing the related application to continue execution. In the case of memory mapped files, the acknowledgement indicated by arrow 307 is generated by the O/S file system. In the case of shared memory, the acknowledgement comes from the O/S virtual memory system. The operating system call interface (not shown) typically provides this acknowledgement functionality.

At step 415, one or more log records 303 are written to I/O device driver 315, as indicated by arrow 311. Log records 303 may be written to disk 331 (via firmware 325, and any intervening hardware, such as device driver 315 and NIC 320) immediately after each acknowledgement 307. Immediately writing each log record 303 may slightly increase system reliability in the event, for example, of near-simultaneous failure of both DBMS and NVRAM battery back-up. Alternatively, multiple log records may be stored or queued in non-volatile memory 310 and periodically ‘batch-written’ to disk after a predetermined number of records are accumulated in non-volatile memory 310, or after a predetermined maximum period of time. ‘Batch-writing’ multiple log records to disk minimizes the amount of disk traffic and the pathlengths associated with each I/O operation.

I/O device driver 315 comprises any driver software or firmware that is used to control interface card 320, which may be a NIC or other device suitable for communicating with storage system 330. Device driver 315 then writes the log record 303 to interface card 320, at step 420, as indicated by arrow 316. At step 425, interface card 320 sends the log record to the disk drive, where it is read by disk firmware 325. As indicated by arrow 321, the log record is sent from interface card 320 to disk firmware 325 via communications fabric 323, which may be a data bus, a local area network, or any other type of network. The log record 303 is then written to a physical disk (target disk) 331, at step 430. as indicated by arrow 326.

Note that the data flow (indicated by arrows 306, 311, 316, 321, 326) in FIG. 3 is essentially unidirectional from DBMS 305 to target disk 331 (with the exception of the acknowledgement sent to DBMS 305 from non-volatile memory 310). This unidirectional data flow reduces response time significantly, enhancing performance while maintaining the Atomicity and Durability properties. Lock residency time is also significantly reduced, improving concurrency and scaling and reducing queuing on locks. DBMS availability is also improved during power outages or following failure of a major system component. In the case of such events, recovery is accomplished by simply restarting the DBMS and the related application—a complex redo-undo sequence is unnecessary, because the current state of all open transactions remains in non-volatile memory 310.

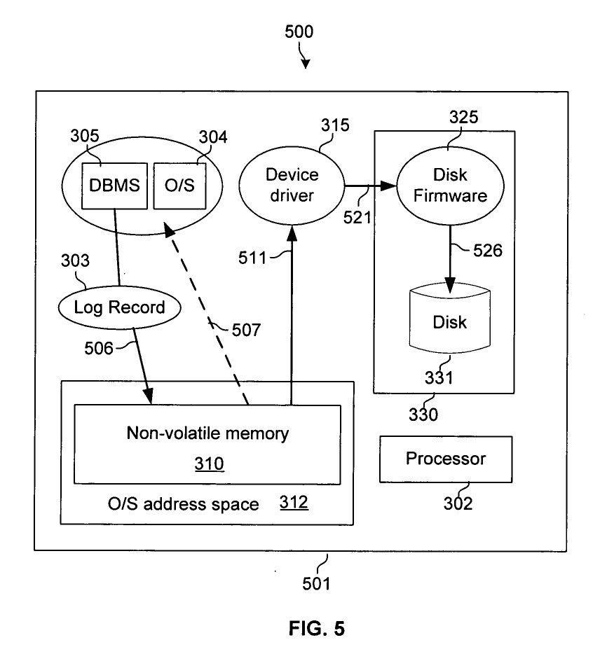

FIG. 5 illustrates an exemplary embodiment 500 of the present transaction logging system wherein the target storage system 330 is essentially ‘local’ to computer system 501. As shown in FIG. 5, system 500 thus comprises computer system 501, which includes target storage system 330, further including target disk 331 and disk controller firmware 325. Computer system 501 includes processor 302, DBMS and associated operating system 305/304, non-volatile memory 310, and I/O device driver 315. Non-volatile memory 310 is part of the address space 312 of the operating system 304.

A comparison of system 500 with system 300 (shown in FIG. 3) shows that network interface card 320 is not present in system 500, and thus the write operations from the log record 303 to the interface card 320 (indicated by arrow 316 in FIG. 3) in system 300 do not occur in system 500. Operation of system 500 is described below with respect to FIG. 6.

FIG. 6 is a flowchart showing an exemplary set of steps performed in operation of an alternative embodiment of the present system. Operation of the present system is best understood by viewing FIGS. 5 and 6 in conjunction with one another. As shown in FIGS. 5 and 6, at step 605, a log record 303 is written from the DBMS 305 to non-volatile memory 310, as indicated by arrow 506. The writing of each log record 303 is initiated by a write request directed to the DBMS from a related application (not shown). DBMS 305 is instructed to perform write operations to non-volatile memory 310 via O/S calls that are employed for allocating memory (e.g., ‘malloc’ calls in UNIX systems).

At step 610, an acknowledgement is sent to the DBMS 305 from non-volatile memory 310 (as indicated by arrow 507) to communicate that the log record 303 was successfully written to non-volatile memory 310. This allows the current DBMS thread to release any latches or locks associated with the write, allowing forward progress of the related application.

At step 615, the log record 303 is written to device driver 315, as indicated by arrow 511. Device driver 315 comprises any driver software or firmware that is used to communicate with storage system 330. In one embodiment, log records 303 are written to disk 331 immediately after each acknowledgement 507. Alternatively, multiple log records are stored or queued in non-volatile memory 310 and periodically ‘batch-written’ to disk after a predetermined number of records are accumulated in non-volatile memory 310, or after a predetermined maximum period of time.

At step 625, device driver 315 then writes the log record 303 to storage system 330, where it is read by disk firmware 325 (as indicated by arrow 521). The log record 303 is then written to a physical disk (target disk) 331, at step 630. as indicated by arrow 526.

Certain changes may be made in the above methods and systems without departing from the scope of that which is described herein. It is to be noted that all matter contained in the above description or shown in the accompanying drawings is to be interpreted as illustrative and not in a limiting sense. For example, the system shown in FIGS. 3 and 5 may be constructed to include components other than those shown therein, and the components may be arranged in other configurations. The elements and steps shown in FIGS. 4 and 6 may also be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall therebetween.

What is claimed is:

1. A transaction logging system for performing log writes in a database management system having associated therewith an operating system and a target storage system to which are written log records corresponding to database transactions, the transaction logging system comprising:
non-volatile memory, accessible by the database management system and directly addressable by the operating system;
wherein, each time one of the log records is written from the database management system to the non-volatile memory, an acknowledgement thereof is sent to the database management system, thereby allowing a lock corresponding to said one of the log records to be released.

2. The transaction logging system of claim 1, wherein each of the log records written to the non-volatile memory is subsequently written to the target storage system.

3. The transaction logging system of claim 1, wherein the non-volatile memory resides in the address space of the operating system.

4. The transaction logging system of claim 1, wherein:
each of the log records is written from the non-volatile memory to the target storage system immediately after each said acknowledgement is sent to the database management system.

5. The transaction logging system of claim 1, wherein:
a plurality of the log records are simultaneously stored in the non-volatile memory and periodically written to the target storage system.

6. The transaction logging system of claim 1, wherein the transaction logging system accesses the target storage system via a network.

7. The transaction logging system of claim 1, wherein the target storage system is local to the transaction logging system.

8. A transaction logging system for performing log writes in a database management system having associated therewith an operating system and a target storage system to which are written log records corresponding to database transactions, the transaction logging system comprising:
non-rotating non-volatile memory residing in the address space of the operating system;
wherein, each time one of the log records is written from the database management system to the non-volatile memory, an acknowledgement thereof is sent to the database management system, thereby causing a lock corresponding to said one of the log records to be released, to allow an associated application to continue execution.

9. The transaction logging system of claim 8, wherein:
each of the log records is written from the non-volatile memory to the target storage system immediately after each said acknowledgement is sent to the database management system.

10. The transaction logging system of claim 8, wherein:
a plurality of the log records are simultaneously stored in the non-volatile memory and periodically written to the target storage system.

11. A method for performing log writes in a database management system having associated therewith an operating system and a target storage system to which are written log records corresponding to database transactions, the method comprising:
including non-rotating non-volatile memory within the address space of the operating system;
writing the log records from the database management system to the non-volatile memory;
providing an acknowledgement to the database management system each time one of the log records is successfully written to the non-volatile memory;
causing a lock corresponding to said one of the log records to be released, in response to receipt of the acknowledgement by the database management system, to allow an associated application to continue execution; and
writing each of the log records from the non-volatile memory to the target storage system.

12. The method of claim 11, further including:
writing each of the log records from the non-volatile memory to the target storage system immediately after each said acknowledgement is sent to the database management system.

13. The method of claim 11, further including:
simultaneously storing a plurality of the log records in the non-volatile memory; and
periodically writing the plurality of log records to the target storage system.

14. A transaction logging system for performing log writes in a database management system having associated therewith an operating system and a target storage system to which are written log records corresponding to database transactions, the transaction logging system comprising:
non-volatile memory means, residing within the address space of the operating system, for storing log records written from the database management system; and
means for providing an acknowledgement to the database management system each time one of the log records is successfully written to the memory means;
wherein each of the log records is written from the non-volatile memory to the target storage system.

15. The transaction logging system of claim 14, wherein each of the log records is written from the non-volatile memory to the target storage system immediately after each said acknowledgement is sent to the database management system.

16. The transaction logging system of claim 14, wherein a plurality of the log records are simultaneously stored in the non-volatile memory and periodically written to the target storage system.

17. A method for performing log writes in a database management system having associated therewith an operating system and a target storage system to which are written log records corresponding to database transactions, the method comprising:
including non-volatile memory within the address space of the operating system;
writing the log records from the database management system to the non-volatile memory; and
providing an acknowledgement to the database management system each time one of the log records is successfully written to the non-volatile memory.

18. The method of claim 17, further including:
writing each of the log records from the non-volatile memory to the target storage system immediately after each said acknowledgement is sent to the database management system.

19. The method of claim 17, further including:
simultaneously storing a plurality of the log records in the non-volatile memory; and
periodically writing the plurality of log records to the target storage system.
